(19) United States
(12) Patent Application Publication
(10) Pub. No.: US 2001/0001533 A1
(43) Pub. Date: May 24, 2001

(54) Method and apparatus for charging a rechargeable battery with monitoring of battery temperature rate of change

(75) Inventors: Kim Arthur Stuck Andersen, Niva (DK); Kim Rasmussen, Ballerup (DK); Kim Ostergaard, Vanlose (DK)

Correspondence Address: Roger L. Maxwell, Jenkens & Gilchrist, A Professional Corporation, Suite 3200, 1445 Ross Avenue, Dallas, TX, 75202-2799, US

(73) Assignee: Chartec Laboratories A/S

(21) Appl. No.: 09/747,507

(22) Filed: Dec. 22, 2000

Related U.S. Application Data
(63) Continuation of application No. 09/047,200, filed on Mar. 24, 1998.

(51) Int. Cl. H01M 10/46

(52) U.S. Cl. 320/150

(57) ABSTRACT

A battery charger monitors an open-circuit voltage across the battery and the rate of change of temperature of the battery to determine a time to terminate the process of charging the battery. Charging proceeds in four stages. In the first stage the open-circuit voltage of the battery is monitored until such voltage crosses a threshold value. In the second stage, the rate of change of battery temperature is monitored to determine a reference value, for example, a minimum of the monitored rate. In the third stage, the rate of change of battery temperature is again monitored to identify a time when such rate exceeds the reference value by a predetermined amount. In the fourth stage, power supplied to charge the battery is limited immediately after stage three or a predetermined time after stage three for example by reducing the charging current to a trickle-charge level or by reducing the voltage by about 100 mV. The predetermined time may be a function of the elapsed charging time, for example a predetermined percentage of about 25%.

### FIELD OF THE INVENTION

The present invention relates to a method and an apparatus for charging a rechargeable battery. More particularly, the present invention is directed to the control of the termination of the charging process.

### BACKGROUND OF THE INVENTION

Generally, when charging a rechargeable battery or a secondary battery, including for example NiCd (Nickel-Cadmium) or NiMH (Nickel-Metal-Hydride), it is known to have a rapid charging process wherein a relatively high constant current is applied to the battery until a certain event occurs. A typical method of detecting this event is to measure the increase in battery temperature as a function of time in order to detect when the battery temperature rate of change (dT/dt or delta_T/delta_t) reaches a predetermined high limit, see for example U.S. Pat. Nos. 3,852,652 to Jasinski, 5,329,219 to Garrett, and 5,550,453 to Bohne et. al.

A common drawback of the above mentioned known charging processes is the use of a constant predetermined reference value to be reached for the measured battery temperature rate of change when terminating the charging process. Use of a predetermined reference value which is constant throughout the battery life sometimes results in undercharge of the battery (leading to a poor battery capacity) or overcharge of the battery (leading to a decreased battery lifetime). Therefore, the need exists for a battery charging method and apparatus that avoid undercharge and overcharge of the battery.

Another drawback of known charging processes in which a characteristic of the battery is monitored for the detecting of an event that indicates the termination of a rapid charging stage, is the appearance of peak values of the characteristic of the battery at the initial stage of charging. To avoid a premature termination of the charging process due to a rise in such a characteristic, the need exists for a battery charging method and apparatus that avoids the detection of the event during the initial charging stage and yet allows the detection of a fully charged battery in order to avoid overcharging of a battery which has already been fully charged.

### SUMMARY OF THE INVENTION

Accordingly, a method in one embodiment of the present invention for charging a rechargeable battery includes the steps of: providing a supplied power to charge the battery; measuring a first characteristic of the battery to provide a first value; measuring a second characteristic of the battery to provide a second value after the first value has crossed a first threshold; and limiting the supplied power after the second value has crossed a second threshold. In alternate methods, the first and second characteristics are each selected from the group consisting of a battery voltage, a charging current, a battery temperature, a rate of change of battery voltage, a rate of change of charging current, and a rate of change of battery temperature and are not the same characteristic. For example the first characteristic may be a battery voltage and the second characteristic may be a rate of change of battery temperature that crosses a threshold based on a minimum of rate of change of battery temperature measured after the battery voltage has crossed a voltage threshold. By limiting supplied power in response to the second value that is measured after the first value had crossed a threshold, premature termination of the charging process is avoided. In a variation of such an alternate method, supplied power is limited in further response to a reference value determined in response to measurements of the second characteristic. Such a reference value accurately accounts for battery technology, battery use, and battery degradation to avoid undercharging the battery and avoid overcharging the battery.

A method in another embodiment of the present invention for charging a rechargeable battery includes the steps of: supplying a charging current to the battery; determining a first plurality of values of rate of change of battery temperature during charging; determining a reference value based on the first plurality of values; determining further values of rate of change of battery temperature; comparing the reference value and these further values; and controlling termination of charging based on the comparison. In an alternate method, the reference value is based on a minimum of the first plurality of values. In another alternate method, the reference value is based on a sum of a minimum of the first plurality of values and a constant.

A method in yet another embodiment of the present invention for charging a rechargeable battery includes the steps of: providing a supplied power to charge the battery, measuring a rate of change of temperature of the battery to provide a first plurality of values and a second value, determining a reference value in response to the first plurality of values, and limiting the supplied power in response to the reference value and the second value. Such a reference value accounts for battery technology, battery use, and battery degradation to avoid undercharging the battery and avoid overcharging the battery.

An apparatus in one embodiment of the present invention for controlling power supplied for charging a rechargeable battery cell includes a circuit that measures a first characteristic of the cell (for example cell voltage), measures a second characteristic of the cell (for example rate of change of cell temperature), and provides a signal for controlling power supplied in response to the second characteristic being measured after the first characteristic crosses a threshold. Operation of the apparatus accounts for battery technology, battery use, and battery degradation to avoid undercharging the cell and avoid overcharging the cell.

An apparatus for charging a rechargeable battery in a second embodiment of the present invention includes the apparatus discussed above for controlling supplied power, and includes a power supply. The power supply, in response to the signal, limits the supplied power. By limiting supplied power in response to the second value that is measured after the first value had crossed a threshold, premature termination of the charging process is avoided. In a variation of this second embodiment, supplied power is limited in further response to a reference value determined in response to the plurality of second values. Such a reference value accurately accounts for battery technology, battery use, and battery degradation to avoid undercharging the battery and avoid overcharging the battery.

An alternate apparatus for charging a rechargeable battery includes: a power supply that provides a supplied power to charge the battery and a circuit that: measures rate of change of a temperature of the battery, determines a minimum of the measured rate of change, determines a present measured rate of change, provides a comparison of the minimum rate of change and the present rate of change, and provides a signal to the power supply in response to the comparison. The power supply, in response to the signal, limits the supplied power.

Yet another alternate apparatus for charging a rechargeable battery includes a power supply that provides a supplied power to charge the battery and a circuit that: measures rate of change of temperature of the battery to provide a first plurality of values and to provide further values of the measured rate of change of the battery temperature, determines a reference value in response to the first plurality of values, compares the further provided values with the reference value, and provides a signal to the power supply in response to this comparison. The power supply limits the supplied power in response to the signal.

Practice of the methods and operation of the apparatus of the present invention reduce or eliminate drawbacks of the prior art.

### BRIEF DESCRIPTION OF THE DRAWING

The structure and operation of exemplary embodiments of the invention, together with further objects and advantages thereof, may best be appreciated by reference to the following detailed description taken in conjunction with the accompanying drawing, in which:

FIG. 1 is a functional block diagram of a battery charging apparatus according to an embodiment of the present invention;

FIG. 2 is a flow chart of a method of charging a rechargeable battery in one embodiment of the invention;

FIG. 3 is a graph of a charging process according to the method of FIG. 2 as applied to an initially fully discharged battery;

FIG. 4 is a graph, of a charging process according to the method of FIG. 2 as applied to a battery having a higher initial temperature than in FIG. 3;

FIG. 5 is a graph of a charging process according to the method of FIG. 2 as applied to a battery having about 90% of its final charge capacity at the beginning of the process; and

FIG. 6 is a graph of a charging process according to the method of FIG. 2 as applied to a battery having a lower initial battery temperature and as performed at a higher ambient charging temperature than in FIG. 3.

### DETAILED DESCRIPTION OF THE PREFERRED EMBODIMENTS

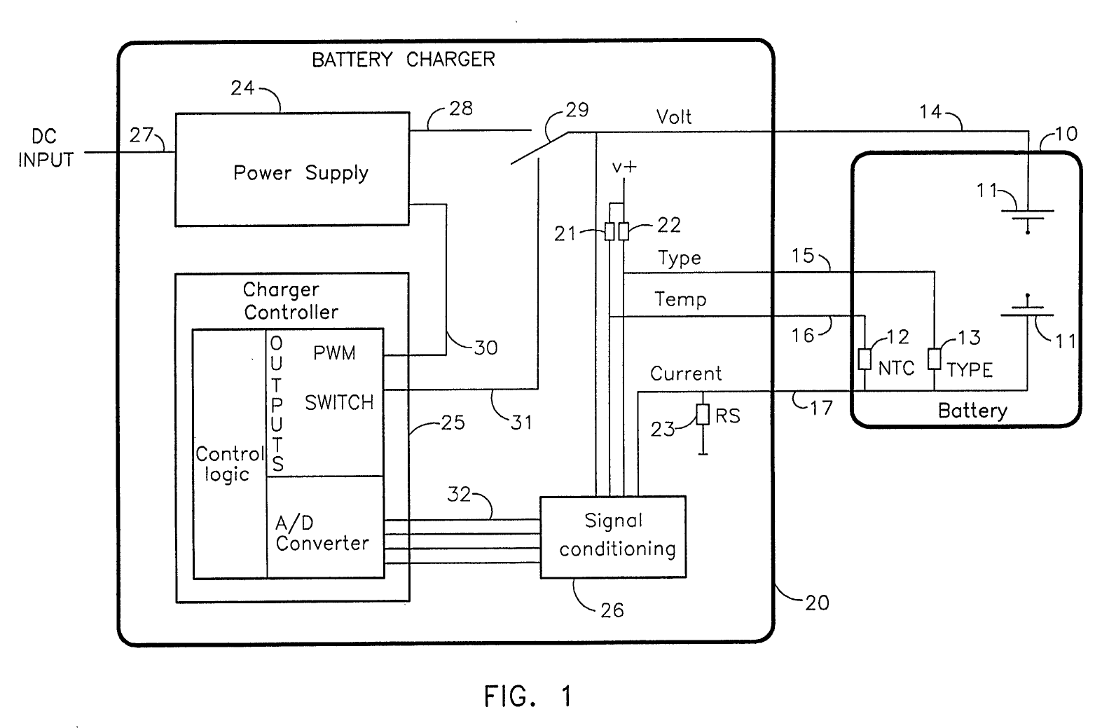

A functional block diagram of a battery charger according to the present invention is illustrated in FIG. 1. FIG. 1 shows battery pack 10 which is to be charged by battery charger apparatus 20. Battery pack 10 comprises a number of series connected individual cells 11, battery temperature sensing thermistor 12 (NTC thermistor), battery type resistor 13, and battery pack output terminals 14, 15, 16, and 17. Battery output voltage is provided across terminals 14 and 17. The charging current supplied to the battery is sensed by sense resistor 23 connected to battery terminal 17 and ground. Thermistor 12 has current supplied through pull-up resistor 21, senses battery temperature, and provides a related output at terminal 16. Type resistor 13 has current supplied through pull-up resistor 22 and provides a battery type related voltage at terminal 15.

In a variation of battery charger 20 and methods of charging rechargeable batteries according to the present invention, type resistor 13 and thermistor 12 are omitted from battery pack 10. An alternate thermistor is located to sense battery temperature when the battery is being charged. And, battery type is presumed or is identified by operator input, by a conventional circuit, or by a conventional mechanical arrangement.

Battery charger 20 includes power supply 24, a charge controller 25, and signal conditioning circuit 26. Power supply 24, preferably a switch mode power supply, has power input 27 which is supplied with a DC voltage, preferably in the range of 12-15 Volts DC. Power supply 24 provides supplied power to charge the battery via output terminal 28, connected to terminal 14 through switch 29. Supplied power is controlled via control output 30 of charge controller 25. When power supply 24 is a switch mode power supply, control output 30 is preferably a pulse width modulated (PWM) signal that may be fed to a filter for converting the PWM signal to a variable analog voltage. The analog voltage may then be used for the control of power supply 24. When using a PWM signal at control output 30, charge controller 25 controls the supplied power to battery 10 via terminal 28 by controlling the duration of on- and off-periods of the PWM signal.

Signal conditioning circuit 26 converts voltage input signals representing the battery terminal voltage, the battery type, the battery temperature, and the charging current, to voltage output signals being suitable as input signals for analog to digital (A/D) converter inputs 32 of charge controller 25. Preferably, current sense resistor 23 has a very low value which may be about 0.1 ohm and conditioning circuit 26 may then include an operational amplifier to provide a suitable output. The supply voltage for charge controller 25 is preferably about 5 volts. Since the battery terminal voltage may exceed 5 volts, conditioning circuit 26 may also include a voltage divider for providing a suitable output signal for the battery terminal voltage.

Charge controller 25 preferably includes switch control output 31 for operating switch 29 on and off. Switch 29 may be turned off at short time intervals during the charging process to measure an open-circuit voltage of the battery, thereby decreasing the effect of the voltage drop from the internal loss resistance when measuring the battery terminal voltage.

Charge controller 25, may include a processor, for example a COP 8ACC marketed by National Semiconductor, programmed to implement battery charging in accordance with the present invention. Charge controller 25 controls the power delivered from power supply 24 to battery 10 based upon the input signals from conditioning circuit 26. These input signals represent characteristics of the battery including battery type, battery terminal voltage, battery temperature, and battery charging current.

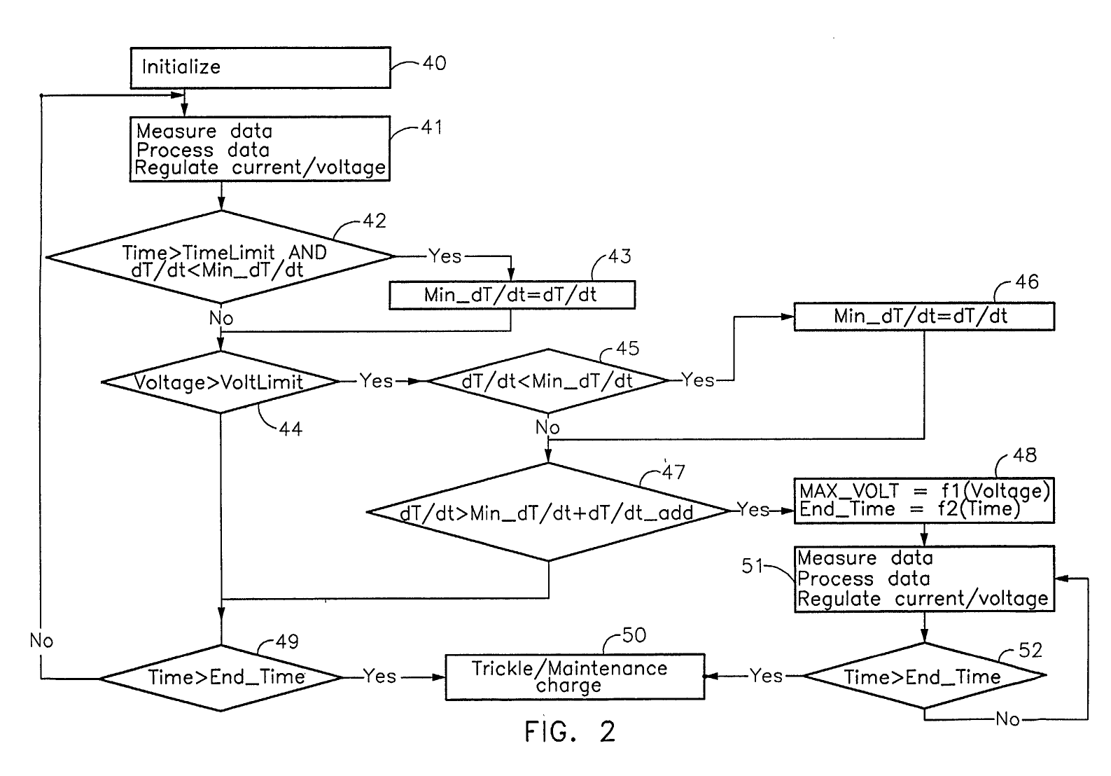

Battery charger apparatus 20 in operation performs one or more methods of charging a rechargeable battery according to the present invention. Such methods are described below with reference to FIGS. 2 through 4.

FIG. 2 presents a method for charging a rechargeable battery according to one embodiment of the present invention. Such a method begins at step 40. At step 40, battery pack 10 is connected to charger 20 and charge controller 25 is initialized.

During initialization, charge controller 25 reads the battery type and battery voltage and uses these values for obtaining predetermined charging parameters stored in charge controller 25. Such parameters may represent a maximum charging current (Imax), an initial value for an end time period (End_Time), a maximum change in the rate of change of battery temperature (dT/dt_add), an initial value for the determined minimum value of the battery temperature rate of change (Min_dT/dt), an initial voltage limit (VoltLimit), and an initial time period (TimeLimit).

End_Time defines a safety time at which the charging process will be stopped unless a new value of End_Time is determined and stored during the charging process.

The value dT/dt_add defines a maximum allowed change in the rate of change of battery temperature compared to Min_dT/dt.

Min_dT/dt is a variable determined during the charging process. The initial value of Min_dT/dt is preferably set to a large value.

VoltLimit defines a minimum limit that the measured battery voltage should reach before updating the predetermined initial value of Min_dT/dt. The value of VoltLimit will typically be 1.4 Volts per battery cell.

TimeLimit defines a time period that expires before updating the predetermined initial value of Min_dT/dt. The value of TimeLimit will typically be 5 minutes for NiCd or NiMH batteries.

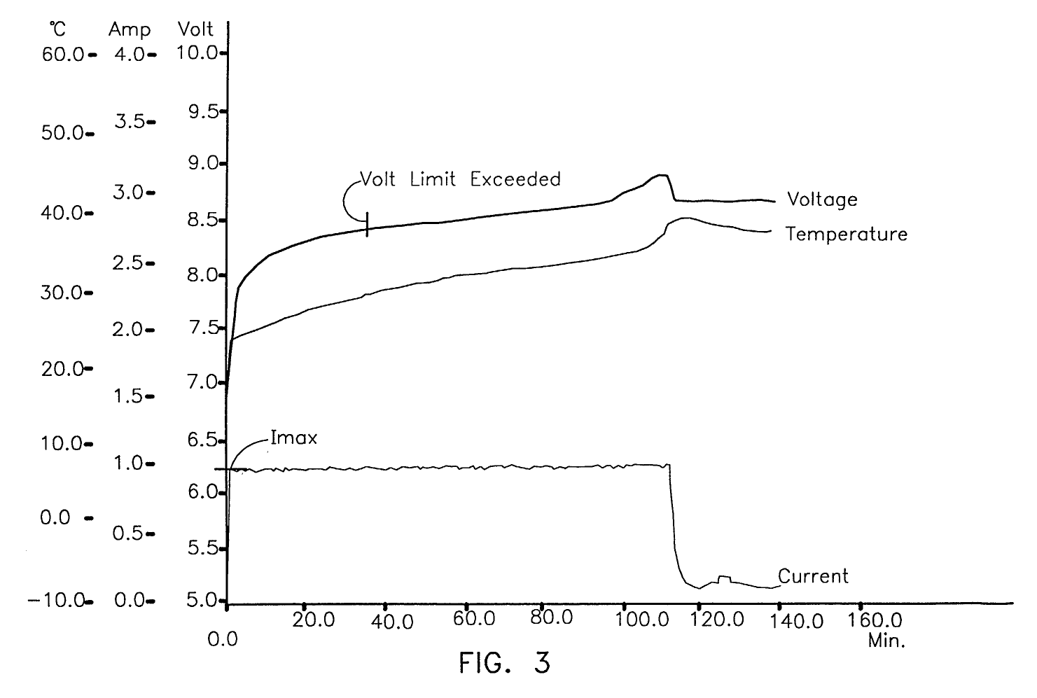

Exemplary initial values of End_Time, Min_dT/dt, and dT/dt_add are given below with the description of FIGS. 3 through 5.

After initialization at step 40 the charging process is begun at process step 41. The charging process is controlled based on measured values of the open-circuit battery voltage (Vopen), the charging current (Ichar), the battery temperature (Tbat), and the elapsed time since charging began (Time). From values of Tbat, values of the battery temperature rate of change (dT/dt) are calculated. During the first stage of the charging process, it is preferred to increase the charging current Ichar until the predetermined Imax has been reached. The magnitude of Imax is predetermined at a value that will quickly charge the battery as opposed to a trickle-charge amount. When Imax has been reached, a second charging stage is entered, in which the output of the power supply is preferably controlled so as to charge at a constant charging current, i.e. the output of the power supply is controlled so that Ichar is close to Imax. In a preferred embodiment, the value of Imax is chosen to be within the range of 0.5 Amp through 1.5 Amp for NiCd and NiMH batteries.

If the measured battery voltage reaches VoltLimit before TimeLimit has expired, the predetermined initial value of Min_dT/dt will be updated and updating will continue from the point in time when VoltLimit had been reached. Otherwise, updating of the predetermined initial value of Min_dT/dt will begin when the TimeLimit period has expired.

At decision step 42, it is determined whether the charging time has reached the stored value of TimeLimit and dT/dt is smaller than the stored value of Min_dT/dt. If so, then at process step 43, the stored value of Min_dT/dt is updated (replaced) with the measured value of dT/dt and the process continues with decision step 44. If the requirements at step 42 are not fulfilled, the process continues directly with decision step 44.

At decision step 44, it is determined whether the measured open-circuit battery voltage (Vopen) has reached the stored value VoltLimit. If not, the process continues with decision step 49.

At decision step 49, it is determined whether the charging time has reached the stored value of End_Time. If not, the process returns to step 41 for further charging. If End_Time has been reached, then the normal charging process is stopped and the charging current is reduced at step 50 to a trickle-charge current (for example a low, maintenance current) to maintain the charged status of the battery.

At step 50, the trickle-charge current is preferably set in the range of 0.05 C through O.I C, where 1 C is equivalent to a charging current in Amps that would theoretically fully charge the battery in one hour.

Here it should be noticed that passing directly from step 44 to step 49 and then to step 50 is not the route of a normal charging process. However, the battery to be charged might be a defective battery or there might be a faulty connection to the battery terminals, leading to the result that the measured battery voltage did not reach the stored VoltLimit value within the initial safety value of End_Time. Thus, the charger will automatically terminate the charging process at expiration of the initial End Time period.

If the measured battery voltage has reached VoltLimit at step 44, the process passes on to decision step 45. At step 45, it is determined whether the measured value of dT/dt is smaller than the stored value of Min_dT/dt. If so, then at process step 46, the stored value of Min_dT/dt is updated (replaced) with the measured value of dT/dt and the process continues with decision step 47. If the requirement at step 45 is not fulfilled, then the process continues directly with decision step 47.

At decision step 47, it is determined whether the measured value of dT/dt is larger than the sum of the presently stored minimum value of the change in dT/dt and the predetermined maximum allowed value of the change in dT/dt. That is, whether the measured value of dT/dt has reached the sum Min_dT/dt plus dT/dt_add. If not, the charging process has not yet reached the normal stage of termination and the process continues with decision step 49, described above. If so, the process continues with process step 48.

At step 48, a third stage of the charging process is entered where the remaining part of the charging process is controlled so that the measured battery voltage does not exceed a maximum allowed battery voltage (MaxVolt). The value of MaxVolt is not a predetermined value, but is a function of the measured battery voltage Vopen_{dT/dt} at the point in time where dT/dt has reached the sum Min_dT/dt plus dT/dt_add. In a preferred embodiment, MaxVolt is defined as fl(Vopen), where fl(Vopen) is defined as (Kl*Vopen_{dT/dt}−k2). The constant kl may be set to 1 and the constant k2 may be set in the range of 0 through 100 mV per cell, preferably about 40 mV, per battery cell. Thus, for a 4 cell battery the value of MaxVolt may preferably be set to Vopen_{dT/dt}−160 mV.

For NiMH batteries it is preferred to have such a reduction in the charging voltage in order to avoid overheating of the battery, since such overheating might damage the battery and decrease the battery lifetime.

The constant k2 may be set in the range of 0 to 50 mV. The constant k2 may be set to zero for NiCd batteries. However, it is preferred to set k2 to about 50 mV for NiCd batteries.

At process step 48, the stored initial value of End_Time is updated (replaced) with a new End_Time value. The new End_Time value is determined as a function of the total charging time Time_{dT/dt} up to the point in time where dT/dt has reached the sum of Min_dT/dt plus dT/dt_add. In a preferred embodiment, the new End_Time value is defined as f2(Time) where f2(Time) is defined as (k3*Time_{dT/dt}+k4). The constant k3 may be set to about 1.25 and the constant k4 may be set to zero. In a variation, k3 can be set in the range of 1 through 2 and k4 can be set to represent a fixed time period in the range of 0 through 20 minutes.

At process step 48, it is determined how the charging process is to be terminated, i.e. a final charging period and the maximum allowed battery voltage are determined. Here it should be mentioned that in a preferred embodiment the measured battery temperature is compensated for variations related to the present rate of change in the battery temperature. Using a maximum allowed battery voltage results in a decrease in the charging current during the final charging period.

The termination of the charging process is illustrated by the loop comprising process step 51 and decision step 52. After the determination of MaxVolt and the new End_Time value, the charging process is continued as described above until the total charging time reaches the stored value of End_Time in step 52.

At step 52, when the total charging time (Time) reaches the stored value of End_Time, the charging process is stopped and the charging current is reduced as already described in step 50 above.

The predetermined charging parameters, including variables, constants, and functions, for the above described preferred embodiment of a method of charging a rechargeable battery are shown Table I.

TABLE I

| | |
|---|---|
| Variables: | |
| Voltage or | Open-circuit battery voltage |
| Vopen | |
| MaxVolt | Maximum allowed voltage across the battery |
| Ichar | Charging current |
| Time | Time elapsed since charging began |
| End_Time | The time when normal charging is to be stopped (initialized |
| | with a safe value and set to an optimized value calculated |
| | during the charging process) |
| Tbat | Battery temperature |
| dT/dt | Rate of battery temperature change |
| Mm_dT/dt | Minimum value of dT/dt during the charging process |
| Constants: | |
| Imax | Maximum allowed charging current |
| End_Time | Predetermined initial charging time safety value |
| Initial | |
| Mm_dT/dt | Predetermined initial minimum value of dT/dt |
| Initial | |
| dT/dt_add | The maximum allowed dT/dt is Mm_dT/dt + dT/dt_add |
| TimeLimit | Mm_dT/dt is updated when Time reaches TimeLimit |
| Initial | (typically about 5 minutes) |
| VoltLimit | Mm_dT/dt is updated when Vopen reaches VoltLimit |
| Initial | (typically 1.4 V for single cell batteries) |
| Functions: | |
| F1(Vopen) | Example: k1 * Vopen · k2 (typically k1 = 1 and |
| | k2 = 40 mV for single cell batteries) |
| F2(Time) | Example: k3 * Time + k4 (typically k3 = 1.25 and k4 = 0) |

FIG. 3 shows a charging process controlled as described above with reference to the flow diagram of FIG. 2 and as applied to charge a fully discharged 1600 mAh NiMH battery with 6 cells. In FIG. 3, the battery is fully discharged before the charging process is begun, and the battery is charged at room temperature with an initial battery temperature about 23° C. In FIG. 3 the thick solid line waveform represents the measured open-circuit battery voltage, the dashed line waveform represents the measured charging current and the thin solid line waveform represents the measured battery temperature.

For the process shown in FIG. 3, predetermined charging parameters are set as follows. Imax is set to 900 mA. The initial End_Time value is set to 160 minutes. The initial value of Min_dT/dt is set to a high value of 10° C./minute, thereby disabling the effect of the rate of temperature change during the upstart of the charging process. The value of dT/dt_add is set to 0.5° C./minute. The value of TimeLimit is set to 5 minutes. And, the value of VoltLimit is set to 8.25 volts. The function f1 for MaxVolt is set to Vopen_{dT/dt}−240 mV, and the function f2 for End_Time is set to 1.25*Time_{dT/dt}.

Here it should be mentioned that the optimal value of dT/dt_add will vary as a function of battery capacity and the maximum charging current. Thus, the value of dT/dt_add should be larger both for a smaller nominal battery capacity and for a higher charging current. In order to measure a relative change in dT/dt of 0.5° C./minute, it is necessary to measure changes in the battery temperature at a relatively high resolution. In a preferred embodiment the temperature is measured using a 10 bit A/D converter resulting in a resolution in change of temperature of about 0.10° C.

It is preferred when comparing Vopen to VoltLimit that VoltLimit be compensated for battery temperature at the time Vopen is measured. Such compensation might be 20 mV/°C. added to VoltLimit for temperatures below 35° C.

The first stage of charging in FIG. 3 is rather short and the charging current reaches Imax within a short time period. During the second stage of charging the current is controlled to approximate Imax. During the third stage of charging, equivalent to the final charging period, the charging current is decreased.

During the second stage of charging, the value of TimeLimit (5 minutes) is smaller than the time at which the compensated voltage Vopen reaches VoltLimit (about 35 minutes). Thus, after TimeLimit has been reached, new values of Min_dT/dt are stored according to steps 42 and 43.

In a preferred embodiment, none of the new values of Min_dT/dt are used for the control of termination of the charging process before VoltLimit has been reached according to step 44. During the charging process dT/dt is measured at regular intervals, but the value of Min_dT/dt is not updated before Time equals (or exceeds) TimeLimit. Further, when Voltage (Vopen) reaches (or exceeds) VoltLimit, the measured values of dT/dt are used for determining termination. These processes can be seen in steps 42 through 45 of FIG. 2.

The battery voltage does not reach the compensated value of VoltLimit until Time is about 35 minutes. At Time equal about 35 minutes, battery temperature is about 27.5° C., and the corresponding voltage compensation is about +150 mV. When Vopen reaches VoltLimit, VoltLimit has a compensated value of about 8.4 volts (8.25+150 mV).

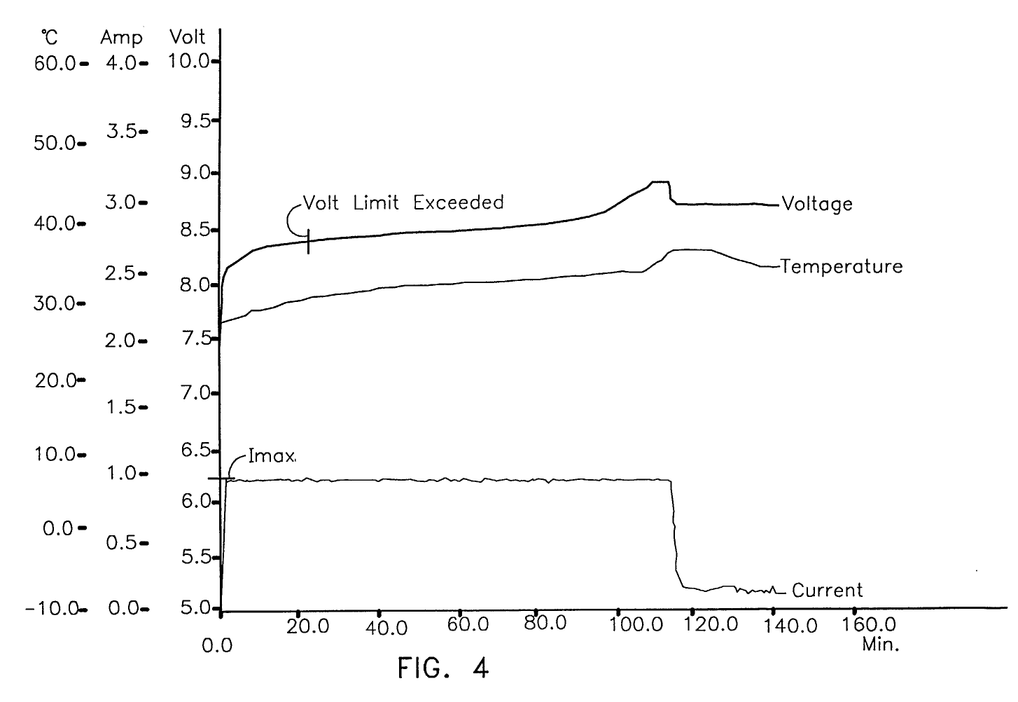

FIG. 4 shows a charging process controlled as described above with reference to the flow diagram of FIG. 2 and as applied to charge a 1600 mAh NiMH battery with 6 cells. In FIG. 4, the battery is charged at the same ambient temperature of about 23° C. as the battery of FIG. 3, but the battery of FIG. 4 has been stored at a higher temperature before being charged, resulting in an initial battery temperature of about 27° C.

In FIG. 4, the predetermined charging parameters are the same as for the charging process of FIG. 3.

Because the battery in FIG. 4 has a higher initial battery temperature, the temperature rate of change dT/dt will be smaller for the charging curves of FIG. 4 than for the curves of FIG. 3. To avoid overcharging the battery, the dT/dt termination value needs to be smaller for the charging process of FIG. 4 than the termination value used for the charging process of FIG. 3. By using an updated value of Min_dT/dt that is smaller for the warm battery of FIG. 4 than for the colder battery of FIG. 3, the resulting maximum allowed value of dT/dt (that is the sum Min_dT/dt plus dT/dt_add) will be smaller in the charging process of FIG. 4 than in the charging process of FIG. 3.

For batteries having lower initial temperatures than the battery of FIG. 3, yet being charged at the same ambient temperature, higher values of dT/dt will be observed during the initial stage of charging, which values might reach the desired termination value of dT/dt. To avoid premature termination of the charging process, the charging process should be controlled so as to avoid termination based on a high value of dT/dt during the initial stage of charging. Such control might be accomplished in a simple way by having a TimeLimit set at a high value, for example 15 minutes. However, setting TimeLimit to a high value might cause overcharging of the battery when an almost fully charged battery is being charged.

According to a variation of a charging method of the present invention, overcharging an almost fully charged battery is avoided. Use of the parameter VoltLimit to determine when values of dT/dt should be used to control termination of the charging process avoids overcharging of almost fully charged batteries. When charging a battery that is already almost fully charged, the battery voltage will reach a high value such as VoltLimit within a relatively short time period, whereas when charging a battery that is almost fully discharged, the battery voltage will increase much more slowly.

In FIG. 4, the battery voltage does not reach the compensated value of VoltLimit until Time is about 22 minutes. At Time equal about 22 minutes, battery temperature is about 30° C., and the corresponding voltage compensation is about +100 mV. When Vopen reaches VoltLimit, VoltLimit has a compensated value of about 8.35 volts (8.25+ 100 mV).

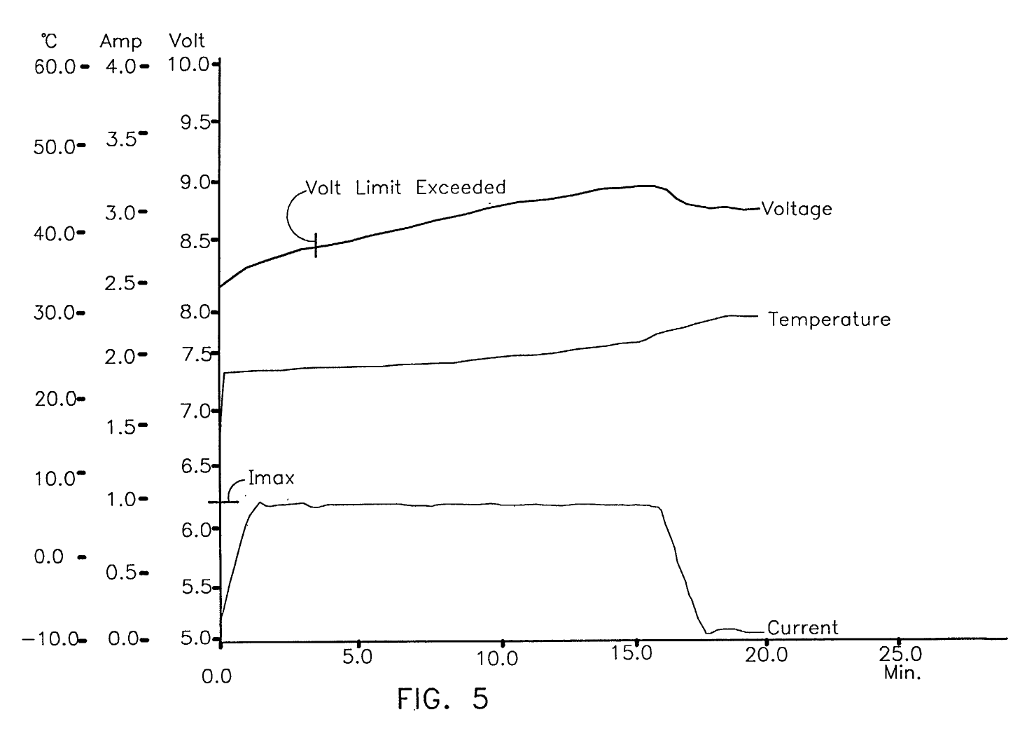

FIG. 5 shows a charging process controlled as described above with reference to the flow diagram of FIG. 2 and as applied to charge a 1600 mAh NiMH battery with 6 cells. The initial battery temperature for the charging process of FIG. 5 is the same as the initial battery temperature for the charging process of FIG. 3. However, in the process of FIG. 5, the battery is holding 90% of its capacity at the beginning of the charging process. In FIG. 5, the battery voltage reaches VoltLimit within 4 minutes from beginning the charging process compared to 35 minutes for the fully discharged battery of FIG. 3.

The battery voltage does not reach the compensated value of VoltLimit until Time is about 4 minutes. At Time equal about 4 minutes, battery temperature is about 23.5° C., and the corresponding voltage compensation is about +230 mV. When Vopen reaches VoltLimit, VoltLimit has a compensated value of about 8.48 volts (8.25+230 mV).

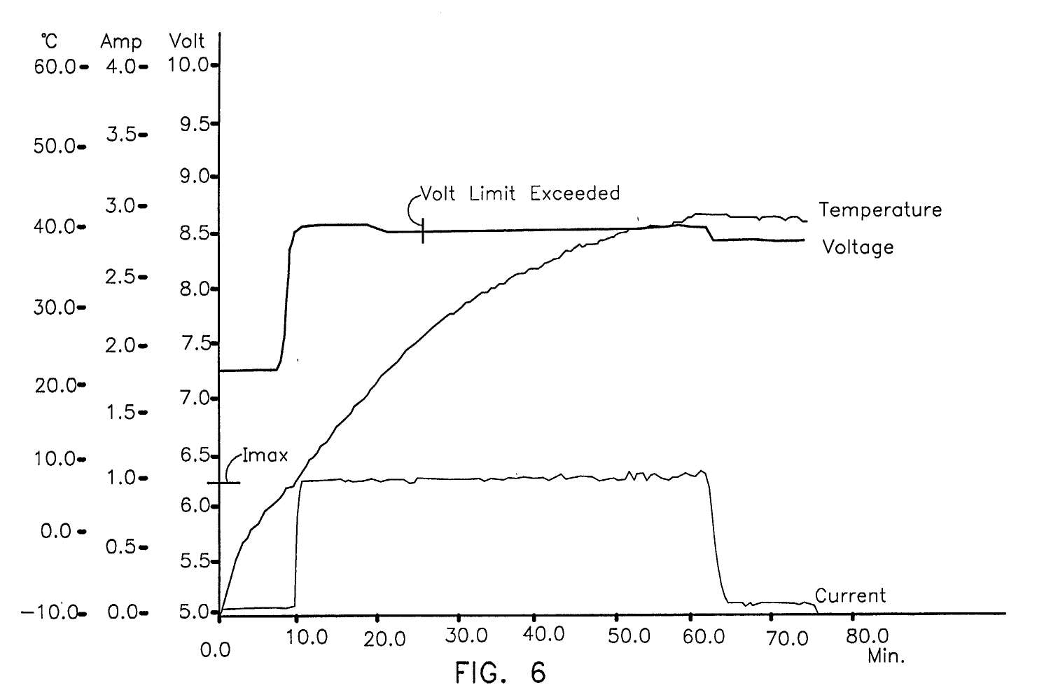

FIG. 6 shows a charging process controlled as described above with reference to the flow diagram of FIG. 2 and as applied to charge a 1600 mAh NiMH battery with 6 cells. In the process of FIG. 6, the battery is holding 50% of its capacity at the beginning of the charging process. However, the initial battery temperature is very low, about −7° C., and the ambient charging temperature is high, about 35° C.

In FIG. 6, the predetermined charging parameters are the same as for the charging process of FIG. 3.

In the charging process of FIG. 6, the battery is charged with a trickle-charge current (for example, a low, maintenance current) until the battery temperature reaches about 5° C., from which point in time a normal charging process is begun. In FIG. 6, the normal charging process is initiated when Time is about 9 minutes. In the process of FIG. 6 the initial value for TimeLimit is set to 5 minutes, as in FIG. 3. Therefore, the value of Min_dT/dt is not updated before Time reaches about 14 minutes (9+5).

The battery voltage does not reach the compensated value of VoltLimit until Time is about 27 minutes. Due to the low battery temperature, the measured values of Vopen should be required to reach a relatively high value before reaching the compensated VoltLimit value. At 25° C., the corresponding voltage compensation is about +200 mV so VoltLimit has a compensated value of about 8.45 volts (8.25+200 mV). When Time is about 27 minutes, the battery temperature has increased to about 25° C. and Vopen reaches about 8.45 volts.

For the process of FIG. 6 the value of Min_dT/dt is not updated before Time equals 14 minutes (according to steps 42 and 43 of FIG. 2). However, after Vopen has reached the compensated VoltLimit, values of dT/dt are used not only to update (replace) the value of Min_dT/dt, but also for determining the termination process (according to steps 44 through 47 of FIG. 2). The value of dT/dt decreases through the charging process until the almost fully charged state is reached. During the charging process, the value of Min_dT/dt is also being decreased until this almost fully charged state is reached. Overcharging the battery is avoided by determining the termination process without requiring the value of dT/dt to reach a fixed value. Rather, the termination process is determined when the value of dT/dt reaches a reference value, Min_dT/dt+ dT/dt_add, which is updated (decreased) during the charging process.

The present invention provides a method where termination of the charging process can be controlled in an optimum way by using a reference value (Min_dT/dt) which is determined during the charging process based on determined values of the rate of change of battery temperature, whereby variation in the reference value between performances of the charging process, for example as a consequence of battery life, has the effect of varying the termination of the charging process to avoid overcharging the battery.

In another embodiment of the present invention, a method for charging a rechargeable battery includes:

connecting an electrical power source to the terminals of the battery and supplying a charging current to the battery,

determining values of the rate of change of battery temperature during at least part of the process of charging the battery,

determining and storing a reference value based on the obtained values of the rate of change of battery temperature,

comparing values of the rate of change of battery temperature with the stored reference value or a function thereof, and

controlling termination of the charging process based on said comparison.

When monitoring battery temperature during a charging process the temperature will increase when the battery approaches the fully charged state. It is preferred to have termination of the charging process based on a threshold value. To allow this threshold value to be adaptive, it is preferred to determine the threshold value based on a plurality of values of the battery temperature rate of change.

For example, termination of the charging process may be initiated when a determined value of the rate of change of battery temperature exceeds a calculated threshold. The threshold value may be calculated by adding a predetermined maximum allowed change in the rate of change of battery temperature (dT/dt_add) to a determined reference value (Min_dT/dt). In order to avoid overcharging of the battery it is preferred that the determined reference value represents a minimum of the obtained values of the rate of change of battery temperature and it is important to use the smallest possible value for the predetermined maximum allowed change. Such a predetermined maximum allowed change may be in the range of 0.25 through 2° C./minute and preferably about 0.5° C./minute. However, the optimal value will depend on battery capacity and battery technology.

To control termination of the charging process, the power supplied to the battery needs to be limited (reduced). Here it is preferred that termination of the charging process includes reducing the charging current. This reduction may be abrupt by turning the power supply off.

The termination of the charging process may alternatively include a final charging period, during which period the battery may be charged with a reduced current until the charging process is finally stopped. Here, the duration of the final charging period may be determined as a function of the total charging time passed at the point in time at which termination of the charging process is initiated. As an example, the length of the final charging period may be in the range of 5% through 50%, preferably about 25%, of the total charging time elapsed up to the point in time at which termination of the charging process is initiated.

The final charging period need not be a function of the charging time but may have a predetermined duration.

To limit power supplied to the battery during the final charging period, the charging process may be controlled so as to reduce battery terminal voltage by at least a predetermined amount during initiation of the final charging period for avoiding overcharging. As an example, the battery terminal voltage may be reduced at least 100 mV, preferably at least 200 mV, at the initiation of the final charging period, with the battery terminal voltage preferably not being increased during this final period.

The battery terminal voltage may also be reduced as a function of the number of cells within the battery. Such a reduction may be in the range of 10 mV through 100 mV per cell, preferably in the range of 20 mV through 70 mV per cell, and even more preferred about 40 mV per cell.

Alternatively, the charging power may be reduced by controlling the charging process so that the battery terminal voltage is not allowed to increase during the final charging period, for example by keeping the voltage constant during this final charging period.

When charging a battery, the determined rate of change of battery temperature during upstart of the charging process may vary as a function of the initial battery temperature. Thus, for a battery which has been stored at a low temperature but which is being charged at a higher temperature, a high value of the rate of change of battery temperature can be observed during upstart of the charging process until the battery has reached the ambient temperature.

To avoid the influence of such an initial high rate of change of battery temperature, it is preferred that the control of the termination of the charging process be based on values of the rate of change of battery temperature as determined after a predetermined time period has lapsed or after the value of a characteristic start-up charging parameter measured during an initial stage of the charging process has reached a predetermined value. In a preferred embodiment the characteristic start-up charging parameter is the battery terminal voltage, which may be measured as an open-circuit voltage.

When the charging process has been stopped, the capacity of the battery may decrease due to self-discharging. Such self-discharging may depend on battery technology (or type) and on individual batteries of the same type.

If self-discharging might be a problem, it is preferred that the state of charge of the battery be maintained after termination of the charging process by a trickle-charge current (for example, a pulsating current or a low, maintenance current).

In yet another embodiment of the present invention, a method of charging a rechargeable battery includes:

connecting an electrical power source to the terminals of the battery and supplying a charging current to the battery,

determining values of a first characteristic charging parameter during at least part of the charging process, and

controlling termination of the charging process based on values of the first parameter being determined after a point in time at which point in time a second characteristic charging parameter measured during an initial stage of the charging process has reached a predetermined value or fulfills a predetermined criteria.

Here, the first characteristic charging parameter may be any characteristic of the battery which is suitable for the control of the charging process such as battery terminal voltage, charging current, battery temperature, the rate of change of any of these parameters or any combination of these parameters and/or their rate of change. Preferably, the first characteristic charging parameter is the rate of change of battery temperature calculated from measured values of the battery temperature.

Similarly, the second characteristic charging parameter may also be selected from any of the above mentioned first characteristic charging parameters with the exception that it should not be the same parameter as the one chosen as the first characteristic parameter. However, it is preferred that the second characteristic charging parameter is the battery voltage.

In order to terminate the charging process it is preferred that the obtained values of the first parameter be compared with a stored reference value or a function thereof, and the termination of the charging process be based on said comparison. Preferably, the termination of the charging process is initiated when the measured values of the first charging parameter reaches a threshold value being a function of the stored reference value. Thus, for example, termination of the charging process may be initiated when the obtained value of the first parameter exceeds the stored reference value by a predetermined amount.

In a preferred embodiment the stored reference value is determined during the charging process based on obtained values of the first parameter. The reference value may be determined as a maximum of the obtained values, but it is preferred that the reference value represents a minimum value of the obtained first parameter values.

When terminating the charging process, it is preferred that the termination includes a final charging period, and it is preferred that the length of the final charging period is determined as a function of the total charging time passed at the point in time at which termination of the charging process is initiated. Furthermore, it is preferred that termination of the charging process includes reducing the charging current or charging with a reduced current during the final charging period.

In FIG. 1, charge controller 25 includes control logic (including memory for storage of variables, constants, and programmed instructions), an analog to digital converter, and input/output circuits. The control logic includes a general purpose arithmetic logic unit (ALU) such as used in the conventional micro controller. Cooperation of the control logic and programmed instructions accomplishes the decision and processing steps described with reference to FIG. 2, including such operations as addressing, identifying, determining, comparing, detecting when a value has crossed a threshold value, calculating, updating, determining elapsed time, responding to inputs, and providing outputs. Cooperation of the control logic and the A/D converter accomplishes steps involving input values, including such operations as measuring, detecting, monitoring, converting, comparing, obtaining, and sensing. Cooperation of the control logic and the output circuit accomplishes controlling power supply 24 and switch 29, including such operations as enabling the provision of supplied power to charge the battery, enabling provision of a trickle-charge current, and limiting supplied power. All such cooperation is accomplished by conventional program development techniques in light of the disclosure of the present invention.

The above description of battery charger 20 of FIG. 1 illustrates a preferred implementation. In alternate implementations, the functions of battery charger 20 are accomplished with analog circuitry, digital circuitry, or any combination of analog and digital circuitry. As one example, charge controller 25 and signal conditioning circuit 26 may be integrated to form a single integrated circuit. As another example, the functions of signal conditioning circuit 26 and the A/D converter portion of charge controller 25 may be combined to form a measurement circuit that provides a digital signal conveying battery temperature or may provide rate of change of battery temperature. Such a measurement circuit may cooperate with a processor that performs all remaining functions of charge controller 25.

What has been described above illustrates how a reference value is compared to the rate of change of battery temperature, which reference value is determined and stored during the charging process. The obtained reference value is used when determining a threshold value for control of termination of the charging process, whereby this embodiment of the present invention implements adaptive battery charging. Such adaptive battery charging allows the present embodiments to account for changes or differences in the threshold value of the battery temperature rate of change due to aging or manufacturing tolerances. Furthermore, such adaptive battery charging allows the present embodiments to account for variations in the threshold value due to differences in ambient temperatures.

The above described embodiments for a charging process also bring a solution which accounts for differences in the initial battery temperature, whereby a premature termination of the charging process due to a high initial temperature rate of change is avoided.

The above described embodiments of the present invention apply to recharging batteries such as NiMH (Nickel Metal Hydride) batteries and other types of rechargeable batteries including, for example, NiCd (Nickel Cadmium) and Lithium batteries.

The foregoing description of preferred exemplary embodiments of the invention has been presented for the purposes of illustration and description. It is not intended to be exhaustive or to limit the invention to the precise form disclosed. Many modifications and variations are possible in light of the description, as will be apparent to those skilled in the art. All such modifications which retain the basic underlying principles disclosed and claimed herein are within the scope of this invention.

What is claimed is:

1. A method for charging a rechargeable battery, the method comprising:
providing a supplied power to charge the battery;
measuring values of rate of change of temperature of the battery to provide a first plurality of values and to provide further values of the measured rate of change of battery temperature;
determining a reference value in response to the first plurality of values;
comparing the further values of the rate of change of temperature of the battery with the reference value; and
limiting the supplied power in response to this comparison.

2. The method of claim 1 wherein the supplied power is limited when the comparison shows that the measured rate of change of temperature differs from the reference value by a predetermined amount.

3. The method of claim 1 wherein the reference value is determined in further response to a minimum of the first plurality of values.

4. The method of claim 1 wherein the step of limiting the supplied power comprises reducing a charging current supplied to the battery.

5. The method of claim 1 wherein the step of limiting the supplied power comprises:
determining a time period duration; and
after lapse of the time period, reducing a charging current supplied to the battery to no more than a trickle-charge current.

6. The method of claim 5 wherein the step of determining a time period duration comprises:
determining a charging duration during which the charging current had been supplied to the battery; and
determining the time period duration in response to the charging duration.

7. The method of claim 6 wherein the step of determining the time period duration comprises setting the time period duration to a duration in the range of 5% to 50% of the charging time lapsed when the step of limiting the supplied power is initiated.

8. The method of claim 5 wherein the step of determining a time period duration comprises setting the time period duration to a constant.

9. The method of claim 1 wherein the step of limiting the supplied power comprises reducing a voltage across the battery.

10. The method of claim 9 wherein the voltage across the battery is reduced at least 100 mV.

11. The method of claim 1 wherein the step of providing a supplied power is performed for a predetermined period prior to performing the step of measuring.

12. The method of claim 1 wherein performance of the step of measuring is deferred until a voltage across the battery crosses a threshold value.

13. The method of claim 1 wherein:
a. the method further comprises the steps of reducing a charging current supplied to the battery, measuring a battery voltage across the battery when the charging current is reduced; and
b. performance of the step of comparing measured rates of change of temperature with the reference value is deferred until the battery voltage crosses a threshold value.

14. The method of claim 1 further comprises providing no more than a trickle-charge current to the battery after performing the step of limiting the supplied power.

15. An apparatus for charging a rechargeable battery, the apparatus comprising:
a. a power supply that provides a supplied power to charge the battery; and
b. a circuit that:
provides indicia of a temperature of the battery;
measures rate of change of the temperature of the battery in response to the indicia to provide a first plurality of values and to provide further values of rate of change of the battery temperature;
determines a reference value in response to the first plurality of values;
compares the further provided values with the reference value; and
provides a signal to the power supply in response to this comparison, wherein the power supply, in response to the signal, limits the supplied power.

16. The apparatus of claim 15 wherein the circuit comprises:
a. a signal conditioning circuit, responsive to the indicia of the temperature of the battery, for providing an analog signal responsive to the temperature of the battery;
b. an analog to digital converter responsive to the analog signal for providing a digital signal; and
c. control logic responsive to the digital signal for providing the signal to the power supply.

17. The apparatus of claim 16 wherein the analog to digital converter and the control logic are integral to an integrated circuit.

18. The apparatus of claim 15 wherein the circuit comprises:
a. a measurement circuit that measures the rate of change; and
b. a control circuit that determines the reference value, compares the further values, and provides the signal to the power supply.

19. The apparatus of claim 18 wherein the measurement circuit comprises an analog to digital converter.

20. The apparatus of claim 15 wherein the signal is provided when the comparison shows that the measured rate of change of temperature differs from the reference value by a predetermined amount.

21. The apparatus of claim 15 wherein the reference value is determined in response to a minimum of the first plurality of values.

22. The apparatus of claim 15 wherein the power supply, in response to the signal, limits the supplied power by reducing a charging current supplied to the battery.

23. The apparatus of claim 15 wherein the signal is provided to the power supply so that a charging current supplied by the power supply to the battery for charging the battery is reduced to no more than a trickle-charge current after lapse of a time period duration beginning from an identified point in time, the circuit determining the time period duration and the identified point in time according to a method comprising:
comparing the further provided values with the reference value to identify the point in time;
determining a charging duration during which the charging current had been supplied to the battery; and
determining the time period duration in response to the charging duration.

24. The apparatus of claim 15 wherein the power supply, in response to the signal, limits the supplied power by reducing a voltage across the battery.

25. The apparatus of claim 15 the wherein measurements for providing the first plurality of values are made after a predetermined period of time during which supplied power is being provided to charge the battery.

26. The apparatus of claim 15 wherein the circuit further measures a voltage across the battery and determines the reference value in further response to the first plurality of values being measured after the voltage across the battery crosses a threshold value.

27. The apparatus of claim 15 wherein:
a. the circuit comprises a device for reducing current supplied to the battery; and
b. the circuit measures the voltage across the battery when current supplied to the battery is reduced.

28. A method for charging a rechargeable battery, the method comprising:
providing a supplied power to quickly charge the battery;
measuring a first characteristic of the battery;
measuring values of a second characteristic of the battery; and
limiting the supplied power in response to values of the second battery characteristic being measured after the first battery characteristic crosses a threshold.

29. The method of claim 28 further comprising:
selecting the first battery characteristic from a group consisting of battery terminal voltage, charging current, battery temperature, rate of change of battery terminal voltage, rate of change of charging current, and rate of change of battery temperature; and
selecting the second battery characteristic from a group consisting of battery terminal voltage, charging current, battery temperature, rate of change of battery terminal voltage, rate of change of charging current, and rate of change of battery temperature, wherein the second battery characteristic is not the same characteristic as the first battery characteristic.

30. The method of claim 28 wherein the step of measuring values of the second battery characteristic comprises measuring a rate of change of a battery temperature.

31. The method of claim 28 wherein the step of measuring the first battery characteristic comprises measuring a voltage across the battery.

32. The method of claim 28 wherein:
the method further comprises determining a reference value in response to the values of the second battery characteristic; and
the step of limiting the supplied power comprises limiting in further response to the reference value.

33. The method of claim 32 wherein:
the method further comprises after determining the reference value, further measuring values of the second battery characteristic; and
the step of limiting the supplied power comprises limiting in further response to comparing the reference value and the further measured values of the second battery characteristic.

34. The method of claim 32 wherein the step of determining comprises setting the reference value in response to a minimum of a plurality of the values of the second battery characteristic.

35. The method of claim 33 wherein the step of comparing the reference value and the further measured values comprises:
forming a difference between the reference value and the further measured values; and
comparing the difference to a predetermined value to provide the comparison of the reference value and the further measured values.

36. The method of claim 28 wherein the step of limiting the supplied power comprises reducing a charging current supplied to the battery.

37. The method of claim 28 wherein the step of limiting the supplied power comprises:
determining a time period duration; and
after lapse of the time period, reducing a charging current supplied to the battery to no more than a trickle-charge current.

38. The method of claim 37 wherein the step of determining a time period duration comprises:
determining a charging duration during which the charging current had been supplied to the battery; and
determining the time period duration in response to the charging duration.

39. An apparatus for charging a rechargeable battery, the apparatus comprising:
a. a power supply that provides a supplied power to quickly charge the battery; and
b. a circuit that:
measures a first characteristic of the battery;
measures a second characteristic of the battery; and
provides a signal to the power supply in response to the second characteristic being measured after the first characteristic crosses a threshold, wherein the power supply, in response to the signal, limits the supplied power.

40. The apparatus of claim 39 wherein the second characteristic is responsive to a rate of change of a battery temperature.

41. The apparatus of claim 39 wherein the first characteristic is responsive to a voltage across the battery.

42. The apparatus of claim 39 wherein the circuit:
measures the second characteristic to provide a plurality of values and to provide further values; and
provides the signal in further response to comparing the plurality of values and the further values.

43. The apparatus of claim 39 wherein the circuit:
measures the second characteristic to provide a plurality of values and to provide further values; and
determines a reference value in response to the plurality of values, compares the reference value to the further values, and provides the signal in further response to the comparison.

44. The apparatus of claim 43 wherein the circuit determines the reference value in response to a minimum of the plurality of values.

45. The apparatus of claim 43 wherein the circuit provides the signal after a measured further value differs from the reference value by a predetermined amount.

46. The apparatus of claim 39 wherein the power supply, in response to the signal, limits the supplied power by reducing a charging current supplied to the battery.

47. The apparatus of claim 39 wherein the circuit provides the signal to the power supply so that a charging current supplied by the power supply to the battery for charging the battery is reduced to no more than a trickle-charge current after lapse of a time period duration beginning from an identified point in time, the circuit determining the time period duration and the identified point in time according to a method comprising:
comparing the reference value and the measured further values to identify the point in time;
determining a charging duration during which the charging current had been supplied to the battery; and
determining the time period duration in response to the charging duration.

48. The apparatus of claim 39 wherein:
a. the circuit selects the first characteristic from a group consisting of battery terminal voltage, charging current, battery temperature, rate of change of battery terminal voltage, rate of change of charging current, and rate of change of battery temperature; and
b. the circuit selects the second characteristic from a group consisting of battery terminal voltage, charging current, battery temperature, rate of change of battery terminal voltage, rate of change of charging current, and battery temperature, wherein the second characteristic is not the same characteristic as the first characteristic.

49. A method for charging a rechargeable battery, the method comprising:
supplying a charging current to the battery;
determining a plurality of values of rate of change of temperature of the battery during at least part of the process of charging the battery;
determining and storing a reference value based on the plurality of values;
after the step of determining the plurality, determining further values of rate of change of temperature of the battery;
comparing further values of rate of change of temperature of the battery to the reference value to provide a comparison; and
controlling termination of the charging process based on the comparison.

50. A method for charging a rechargeable battery, the method comprising:
supplying a charging current to the battery;
determining a plurality of values of rate of change of temperature of the battery during at least part of the process of charging the battery;
determining and storing a reference value based on a minimum of the plurality of values;
after the step of determining the plurality, determining further values of rate of change of temperature of the battery;
comparing further values of rate of change of temperature of the battery to the reference value to provide a comparison; and
controlling termination of the charging process based on the comparison.

51. A method for charging a rechargeable battery, the method comprising:
supplying a charging current to the battery;
determining a plurality of values of rate of change of temperature of the battery during at least part of the process of charging the battery;
determining and storing a reference value based on a sum of a minimum of the plurality of values and a constant;
after the step of determining the plurality, determining further values of rate of change of temperature of the battery;
comparing further values of rate of change of temperature of the battery to the reference value to provide a comparison; and
controlling termination of the charging process based on the comparison.

52. A method for charging a rechargeable battery, the method comprising:
providing a supplied power to charge the battery;
measuring rate of change of a temperature of the battery to provide a plurality of measurements and later a second plurality of measurements;
determining a reference value in response to the plurality;
comparing the reference value to each measurement of the second plurality to provide a comparison; and
limiting the supplied power in response to the comparison.

53. A method for charging a rechargeable battery, the method comprising:
providing a supplied power to charge the battery;
measuring rate of change of a temperature of the battery to provide a plurality of measurements and later a second plurality of measurements;
determining a reference value in response to a minimum of the plurality;
comparing the reference value to each measurement of the second plurality to provide a comparison; and
limiting the supplied power in response to the comparison.

54. A method for charging a rechargeable battery, the method comprising:
providing a supplied power to charge the battery;
measuring rate of change of a temperature of the battery to provide a first plurality of measurements and later a second plurality of measurements;
determining a reference value in response to a sum of a minimum of the first plurality and a constant;
comparing the reference value to each measurement of the second plurality to provide a comparison; and
limiting the supplied power in response to the comparison.

55. A method for charging a rechargeable battery, the method comprising:
providing a supplied power to charge the battery;
measuring rate of change of a temperature of the battery to provide a first plurality of values and a second value; and
limiting the supplied power in response to the second value and to a minimum of the first plurality of values.

56. The method of claim 55 wherein supplied power is limited after a first time when the second value exceeds a sum of a constant and the minimum of the first plurality of values.

57. The method of claim 56 wherein the step of limiting the supplied power comprises:
determining a time period duration; and
after occurrence of the first time and after lapse of the time period, reducing a charging current supplied to the battery to no more than a trickle-charge current.

58. The method of claim 57 wherein the step of determining a time period duration comprises:
determining a charging duration during which the charging current had been supplied to the battery; and
determining the time period duration in response to the charging duration.

59. The method of claim 58 wherein the step of determining the time period duration comprises setting the time period duration to a duration in the range of 5% to 50% of the charging duration occurring prior to the first time.

60. The method of claim 57 wherein the step of determining a time period duration comprises setting the time period duration to a constant.

61. The method of claim 55 wherein performance of the step of measuring is deferred during a predetermined initial portion of the performance of the step of providing supplied power.

62. The method of claim 55 wherein performance of the step of measuring is deferred until a voltage across the battery crosses a threshold value.

63. A method for charging a rechargeable battery, the method comprising:
providing a supplied power to quickly charge the battery;
measuring a first characteristic of the battery to provide a first value;
after the first value crosses a first threshold, measuring a second characteristic of the battery to provide a second value; and
after the second value crosses a second threshold, limiting the supplied power.

64. The method of claim 63 wherein:
a. the first characteristic is selected from the group consisting of a battery voltage, a charging current, a battery temperature, rate of change of a battery voltage, rate of change of a charging current, and rate of change of battery temperature;
b. the second characteristic is selected from the group consisting of a battery voltage, a charging current, a battery temperature, rate of change of a battery voltage, rate of change of a charging current, and rate of change of battery temperature; and
c. the second characteristic is not the same characteristic as the first characteristic.

65. The method of claim 64 wherein the method further comprises:
determining a minimum of the second characteristic; and
determining the second threshold in response to the minimum.

66. The method of claim 65 wherein the second characteristic is determined to have crossed the second threshold when a difference between the second characteristic and the second threshold exceeds a predetermined amount.

67. The method of claim 66 wherein the step of limiting the supplied power comprises:
determining a time period duration; and
after lapse of the time period, reducing a charging current supplied to the battery to no more than a trickle-charge current.

68. The method of claim 67 wherein the step of determining a time period duration comprises:
determining a charging duration during which the charging current had been supplied to the battery; and
determining the time period duration in response to the charging duration.

69. An apparatus for charging a rechargeable battery, the apparatus comprising:
a. a power supply that provides a supplied power to charge the battery; and
b. a circuit that:
measures rate of change of the temperature of the battery;
determines a minimum of the measured rate of change;
determines a present measured rate of change;
provides a comparison of the minimum rate of change and the present rate of change; and
provides a signal to the power supply in response to this comparison, wherein the power supply, in response to the signal, limits the supplied power.

70. The apparatus of claim 69 wherein the circuit provides the comparison as a difference between the minimum rate of change and the present rate of change and provides the signal when the comparison exceeds a predetermined amount.

71. The apparatus of claim 70 wherein the circuit provides the signal to the power supply so that a charging current supplied by the power supply to the battery for charging the battery is reduced to no more than a trickle-charge current after lapse of a time period duration beginning from an identified point in time, the circuit determining the time period duration and the identified point in time according to a method comprising:
a. identifying the point in time as the time when the comparison exceeds the predetermined amount;
b. determining a charging duration during which the charging current had been supplied to the battery; and
c. determining the time period duration in response to the charging duration.

72. The apparatus of claim 71 wherein the power supply, in response to the signal, limits the supplied power by maintaining a reduced voltage across the battery.

73. The apparatus of claim 72 wherein the reduced voltage is maintained at a constant value during the time period.

74. The apparatus of claim 73 wherein the battery comprises at least one cell and the voltage is reduced by an amount of about 40 millivolts per cell.

75. The apparatus of claim 69 wherein determining the minimum rate of change is deferred until after lapse of a period of time during which supplied power is being provided to charge the battery.

76. The apparatus of claim 69 wherein the lapse of the period of time occurs in response to determining that a voltage across the battery has crossed a threshold value.

77. The apparatus of claim 76 wherein the threshold value is determined in response to the voltage across the battery compensated for the temperature of the battery.

78. An apparatus for controlling power supplied for charging a rechargeable battery, the battery comprising at least one cell, the apparatus comprising a circuit that:
measures a first characteristic of the cell while power is being supplied to quickly charge the cell;
measures a second characteristic of the cell; and
provides a signal to control supplied power in response to the second characteristic being measured after the first characteristic crosses a threshold.

79. The apparatus of claim 78 wherein the first characteristic is responsive to a voltage of the cell.

80. The apparatus of claim 79 wherein the second characteristic is responsive to rate of change of a temperature of the cell.

81. The apparatus of claim 80 wherein:
a. the circuit decreases a reference value in response to decreasing measurements of the second characteristic made after the first characteristic crosses the threshold; and
b. the circuit provides the signal in response to a measurement of the second characteristic that exceeds the reference value by a predetermined amount.

82. The apparatus of claim 81 wherein the circuit adjusts the threshold in response to the temperature of the cell.

83. The apparatus of claim 82 wherein:
a. the supplied power comprises a charging current;
b. the circuit provides the signal for reducing the charging current to no more than a trickle-charge current after lapse of a time period duration beginning from an identified point in time; and
c. the circuit determines the time period duration and the identified point in time according to a method comprising:
identifying the point in time in response to the time when a measurement of the second characteristic that exceeds the reference value by a predetermined amount; determining a charging duration during which the charging current had been supplied to the cell; and
determining the time period duration in response to the charging duration.
